(19) United States
(12) Patent Application Publication
(10) Pub. No.: US 2016/0186390 A1
(43) Pub. Date: Jun. 30, 2016

(54) FEEDING APPLIANCE AND METHOD FOR CONVERSION OF THE SAME

(71) Applicant: Dynapac GmbH, Wardenburg (DE)

(72) Inventors: Rainer Bippen, Hamburg (DE); Seby Joseph, Wardenburg (DE); Hauke Brammer, Grossenkneten (DE)

(73) Assignee: Dynapac GmbH, Wardenburg (DE)

(21) Appl. No.: 15/064,973

(22) Filed: Mar. 9, 2016

Related U.S. Application Data
(62) Division of application No. 14/219,465, filed on Mar. 19, 2014.

(30) Foreign Application Priority Data
Mar. 20, 2013 (DE) 102013004757.9

(51) Int. Cl. E01C 23/00; B65G 41/00; B65G 37/00

(52) U.S. Cl. CPC E01C 23/00; B65G 37/00; B65G 41/002

(57) ABSTRACT

Feeding appliances have an elongate continuous conveyor (14) which serves as a distributing conveyor. The distributing conveyor is required only in certain usage situations. Said distributing conveyor must thus be detached when not in use. Detachment is also required for the transportation of the feeding appliance by road. In the case of known feeding appliances, the attachment and detachment of the longitudinal conveyor (17), which serves as distributing conveyor, is cumbersome. The invention provides for the longitudinal conveyor (17) to be connected to a running gear (12) of the feeding appliance by being hooked on or hooked in. This can be realized by virtue of the longitudinal conveyor (17) being simply lowered or raised by a suitable lifting means, for example a crane. Time-consuming and difficult alignment work is thus eliminated.

### STATEMENT OF RELATED APPLICATIONS

This application is a divisional and claims the benefit of U.S. patent application Ser. No. 14/219,465 having a filing date of 19 Mar. 2014, which claims the benefit of German Patent Application No. 10 2013 004 757.9 having a filing date of 20 Mar. 2013.

### BACKGROUND OF THE INVENTION

1. Technical Field

The invention relates to a method for conversion of a feeding appliance, wherein a longitudinal conveyor is detached from the running gear of the feeding appliance and, for commencement of operation, is attached again, and, for the attachment and detachment, the handling of the longitudinal conveyor is performed by a lifting device. The invention also relates to a feeding appliance having a running gear which is assigned, at the front as viewed in a paving direction, a storage container for accommodating a supply of material, having a rear longitudinal conveyor which is fastenable to the running gear, and having at least one conveyor that transports the material from the storage container to the longitudinal conveyor.

2. Prior Art

Feeding appliances serve inter alia for supplying road-finishing machines with material for producing a pavement surface. Heavy goods vehicles transport the material to the feeding appliances. The feeding appliances have storage containers which serve for temporarily storing the material and which transport said material to the respective road-finishing machine as required. The feeding appliances, as temporary stores, permit continuous operation of the respective road-finishing machine even if no material is delivered by a heavy goods vehicle for a relatively long period of time. Feeding appliances are however also used for supplying material to other construction machines, including other road-building machines, and to construction sites.

Relatively large feeding appliances in particular have a longitudinal conveyor, also referred to as a distributor belt, by means of which the material is transported from the feeding appliance to the road-finishing machine, in particular to the storage container assigned thereto. The longitudinal conveyor is often also used for supplying material to multiple road-finishing machines which are travelling for example adjacent to one other. Road-finishing machines also exist which require a relatively large offloading height for the material. For the above-mentioned purposes in particular, the longitudinal conveyors must be relatively long. As a result, in order for the feeding appliance to be transported from one construction site to another, it is necessary for the longitudinal conveyor to be detached such that the feeding appliance and the longitudinal conveyor can be transported separately. The detachment and attachment of the longitudinal conveyor is time-consuming and not easy.

### BRIEF SUMMARY OF THE INVENTION

The invention is based on the object of providing a feeding appliance and a method for conversion of the same, whereby simple and rapid detachment and attachment of the longitudinal conveyor are possible.

A method for achieving said object is a method for conversion of a feeding appliance, wherein a longitudinal conveyor is detached from the running gear of the feeding appliance and, for commencement of operation, is attached again, and, for the attachment and detachment, the handling of the longitudinal conveyor is performed by a lifting device, characterized in that the longitudinal conveyor is automatically hooked onto the running gear by means of manoeuvring performed by the lifting device. Accordingly, provision is made for the longitudinal conveyor, by being lowered, to be hooked onto the running gear of the feeding appliance, specifically preferably by being hooked in. It is preferable for the longitudinal conveyor to be lowered vertically in order for it to be hooked onto the running gear of the feeding appliance. Such a lowering movement may be performed in a simple manner by a lifting means. Owing to the hooking-in process, the connection between the longitudinal conveyor and the running gear of the feeding appliance is realized automatically, in particular in an enforced manner.

The method is preferably refined in that, after the hooking-on of the longitudinal conveyor onto the running gear, following which said longitudinal conveyor remains releasably connected to said running gear, the connection of the longitudinal conveyor to the running gear is additionally secured, preferably by positively locking action. In this way, a connection of the longitudinal conveyor to the running gear is realized which cannot be inadvertently released, and which can be released only if the securing action has previously also been eliminated.

In one preferred refinement of the method, it is provided that, for the hooking-on of the longitudinal conveyor onto the running gear, at least one projection on the longitudinal conveyor is lowered into an upwardly open, corresponding depression on the running gear, or a downwardly open depression on the longitudinal conveyor is lowered onto a corresponding projection on the running gear. Thus, at least one hook-in connection is produced between the longitudinal conveyor and the running gear when the longitudinal conveyor is lowered relative to the running gear during the attachment process.

One advantageous refinement of the method provides that the longitudinal conveyor has a coupling means. The longitudinal conveyor is then hooked into and or secured on the running gear by way of the coupling means. The coupling means then has the at least one projection or the at least one depression and at least one securing means for preventing inadvertent detachment of the at least one hook-like hooking-in means of the longitudinal conveyor, with the coupling means, on the running gear.

A feeding appliance for achieving this object is a feeding appliance having a running gear which is assigned, at the front as viewed in a paving direction, a storage container for accommodating a supply of material, having a rear longitudinal conveyor which is fastenable to the running gear, and having at least one conveyor that transports the material from the storage container to the longitudinal conveyor, characterized in that the longitudinal conveyor is connectable to the running gear by way of at least one hooking-in means and at least one locking means. In the case of said feeding appliance, it is provided that the longitudinal conveyor is preferably releasably connectable to the running gear by way of at least one hooking-in means and at least one locking means. By way of the at least one hooking-in means, the longitudinal conveyor can be connected to the running gear of the feeding appliance, without bolts, simply by being lowered. The at least one hooking-in means centers the longitudinal conveyor in the intended relative position with respect to the running gear. Thereafter, the at least one securing means, which may be of any desired form, can be engaged in a simple and in particular rapid manner. Here, the at least one securing means has merely the task of locking the longitudinal conveyor in the at least one hooking-in means on the running gear in order that inadvertent release of the connection of the longitudinal conveyor to the running gear is no longer possible during the operation of the feeding appliance. By virtue of the at least one securing means being released, the longitudinal conveyor can be detached from the running gear of the feeding appliance by simply being unhooked.

It is preferable for the at least one hooking-in means to be arranged at a different location than the securing means. In particular, the hooking-in means is arranged above the at least one locking means, in particular substantially vertically above the locking means. In this way, after the insertion of the longitudinal conveyor into the at least one hooking-in means, the longitudinal conveyor is held under its own weight on the running gear in an accurately positioned manner, such that the respective locking for securing the longitudinal conveyor in the state in which it is hooked onto the running gear is possible in a simple manner, without the longitudinal conveyor having to be suspended in a lifting apparatus again for this purpose.

Provision is also preferably made for the longitudinal conveyor to be assigned a coupling means, or for the longitudinal conveyor to be provided with a coupling means of said type. The longitudinal conveyor with the coupling means is then connectable to the running gear by way of the at least one hooking-in means and locking means. Here, the coupling means is suitable as a carrier for projections or depressions of the hooking-in means and as a carrier of parts of the locking means.

In one advantageous refinement of the invention, it is provided that the longitudinal conveyor is, directly or by way of its coupling means, immovably and/or rigidly connectable to the running gear. In this way, it is ensured that the longitudinal conveyor is coupled in a defined and substantially play-free manner, in particular by way of the coupling means assigned thereto, to the running gear. In this way, the longitudinal conveyor cannot perform any uncontrolled or undesired movements relative to the running gear.

It is advantageous for the respective hooking-in means to be composed of an upwardly open depression on the running gear and of a projection, corresponding to each depression, on the longitudinal conveyor or on the coupling means. It is alternatively also conceivable for at least one downwardly open depression to be provided on the longitudinal conveyor or on the coupling means, which depression corresponds to a projection on the running gear. In this way, simple hook-action connections are created which can be assembled in a simple manner and also released again in a simple manner. In particular, it is conceivable for the depressions to widen in a V-shape toward the open side, with automatic centring between the projection and the depression thus being realized.

In one preferred refinement of the feeding appliance, the respective locking means below the associated hooking-in means is in the form of a positively locking connection, which acts preferably in all directions, between the longitudinal conveyor or the coupling means and the running gear. Furthermore, the positively locking connection is assigned to the running gear and to the longitudinal conveyor or the coupling means such that the positively locking connection can be produced after the hooking-on of the longitudinal conveyor, in particular of the coupling means assigned thereto, onto the running gear. It is also the case that, during the production of the at least one hooking-in connection, the components of each locking means are oriented or centred with respect one another such that, without changes in position of the longitudinal conveyor or of the coupling means with respect to the running gear, it is possible for the respective locking means to be engaged.

It is preferably provided that the longitudinal conveyor is supported on the coupling means, preferably on that end region of the coupling means which is directed away from the running gear, about a vertical or slightly inclined, upright pivot axis. In this way, the longitudinal conveyor can be pivoted laterally relative to the coupling means, specifically to opposite sides. In this case, the coupling means maintains the fixed or rigid position relative to the running gear as predefined by the hooking-in means and the locking means. Thus, only the longitudinal conveyor, but not the coupling means, is pivotable.

Provision is preferably also made for the longitudinal conveyor to be assigned a pivoting means which is connected to the coupling means pivotably about the upright or slightly inclined pivot axis, wherein the longitudinal conveyor is connected to the pivoting means pivotably about a horizontal tilt axis. If the longitudinal conveyor and the tilt axis are tilted, that free end of said longitudinal conveyor which is directed away from the running gear, that is to say the offloading end, can be moved up and down according to requirements. For the pivoting of the offloading end of the longitudinal conveyor up and down, only a relative movement of the longitudinal conveyor with respect to the pivoting means is performed, without a relative movement of the pivoting means with respect to the coupling means. It is however alternatively also conceivable for the longitudinal conveyor to be supported on the coupling means pivotably both about the vertical pivot axis and also about the horizontal pivot axis. The pivoting means may then be omitted.

Another advantageous refinement of the feeding appliance provides that the longitudinal conveyor is assigned a drive, preferably a hydraulic drive, for its encircling conveyor belt. It is preferable for the drive to be assigned to a free offloading end, which is directed away from the running gear, of the longitudinal conveyor. By means of the dedicated drive, the longitudinal conveyor can supply the material to the road-finishing machine in a targeted manner, specifically at a variable rate per unit of time. The assignment of the drive to the free offloading end of the longitudinal conveyor creates space, at that end of the longitudinal conveyor which points towards the running gear, for the required means for the lateral pivoting and upward and downward pivoting of the longitudinal conveyor. Furthermore, the drive can be attached and detached together with the longitudinal conveyor.

### BRIEF DESCRIPTION OF THE DRAWINGS

A preferred exemplary embodiment of the invention will be explained in more detail below on the basis of the drawing, in which:

FIG. 1 shows a schematic side view of a feeding appliance with a longitudinal conveyor attached thereto,

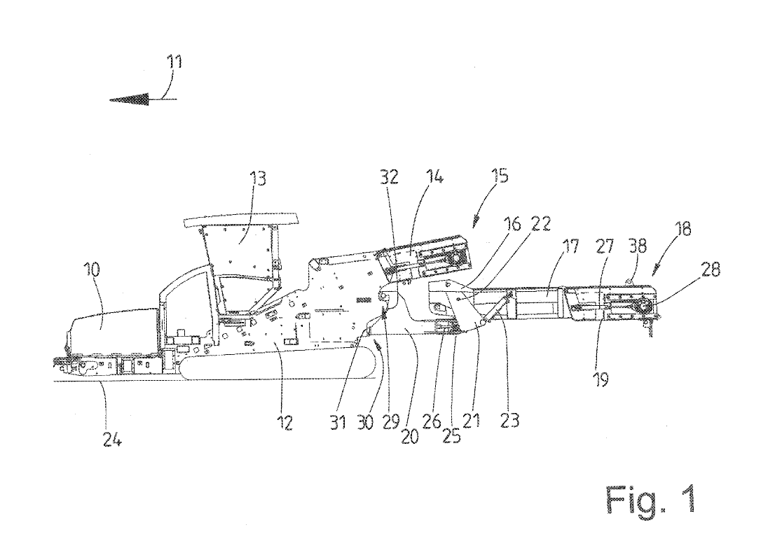

FIG. 2 shows a side view of the feeding appliance of FIG. 1 with the longitudinal conveyor detached,

FIG. 3 shows a view similar to FIG. 2, with a longitudinal conveyor hanging from a lifting apparatus,

FIG. 4 shows a view similar to FIGS. 2 and 3, with the longitudinal conveyor having been lifted (so as to be in a freely floating state) by the lifting apparatus, and

FIG. 5 shows a view similar to FIGS. 2 to 4, with the longitudinal conveyor hooked onto the feeding appliance but still hanging from the lifting apparatus.

### DETAILED DESCRIPTION OF PREFERRED EMBODIMENTS

The feeding appliance shown in the figures serves for example for supplying one or more road-finishing machines (not illustrated) with material for the laying of a pavement surface. The material is transported onto site discontinuously by conventional heavy goods vehicles and is tipped into a storage container 10 of the feeding appliance. Material for the pavement surface to be produced is supplied to the road-finishing machine as required by the feeding appliance. In this way, the road-finishing machine can perform the laying of the road material in continuous fashion, specifically even in phases in which no material is currently being transported onto site by heavy goods vehicles. If appropriate, it is also possible for the material to be distributed to multiple road-finishing machines by one feeding appliance.

The heavy goods vehicles tip the material into the storage container 10 of the feeding appliance, said storage container being situated at the front as viewed in the paving direction 11 of the pavement surface. The feeding appliance then transports the material to the rear end thereof, counter to the paving direction 11, as required, said material being conveyed onward from there to the road-finishing machine travelling behind the feeding appliance as viewed in the paving direction 11, or to multiple road-finishing machines travelling behind or adjacent to one another behind the feeding appliance. It is preferable for the material from the feeding appliance to be offloaded into a storage container of the road-finishing machine travelling behind it, or alternately into storage containers of multiple road-finishing machines travelling behind the feeding appliance.

The feeding appliance shown here is of self-propelling design. It has a chassis or running gear 12 which, in the exemplary embodiment shown, is a track-type running gear. The feeding appliance may however also have a wheel-type running gear. As viewed in the paving direction 11, the storage container 10 is arranged on the front side of the feeding appliance. The storage container 10 of the feeding appliance normally has a volumetric capacity larger than that of the storage container of a conventional road-finishing machine. Behind the storage container 10 as viewed in the paving direction 11, the feeding appliance has a primary drive source (not shown in any more detail), for example a diesel engine, and behind the latter, an operators' platform 13. By means of an intermediate conveyor (not shown), normally a scraper conveyor, the material is transported from the storage container 10 to the rear side of the running gear 12 counter to the paving direction 11. The material then passes onto a continuous conveyor 14 which may be in the form of a conveyor belt or a scraper conveyor. From an offloading end 15 of the continuous conveyor 14, which offloading end is at the rear as viewed in the paving direction 11 and which points towards the following road-finishing machine, the material used for the production of the pavement surface passes either directly into the storage container of a following road-finishing machine or (as in the illustration in the drawings), onto the front charging end 16 of a longitudinal conveyor 17. The longitudinal conveyor 17 is used predominantly for distributing the material to multiple road-finishing machines following the feeding appliance. Therefore, in technical jargon, the longitudinal conveyor 17 is also referred to as “distributor belt”. The material used for producing a pavement surface is offloaded, from a rear offloading end 18 of the longitudinal conveyor 17, into the storage container of the respective road-finishing machine to be fed. The longitudinal conveyor 17 is also used with the feeding appliance if material is to be fed to large road-finishing machines for producing relatively broad pavement surfaces or to multi-layer finishing machines with storage containers arranged at a very great height.

For the transportation of the feeding appliance from one construction site to another, or if material is to be supplied to a road-finishing machine directly from the offloading end 15 of the continuous conveyor 14, the longitudinal conveyor 17 must be detached from the running gear 12 of the feeding appliance. The invention is concerned with a simplification of the detachment and attachment of the longitudinal conveyor 17 or of the distributor belt.

The longitudinal conveyor shown here is formed from the elongate continuous conveyor 19 itself with an encircling conveyor belt, a coupling means 20 and a pivoting means 21. In the region of its charging end 16, the longitudinal conveyor 17 is mounted, so as to be variable in inclination about a horizontal tilt axis 22, on the pivoting means 21. Pressure medium cylinders, in particular hydraulic cylinders 23, are provided on opposite sides of the longitudinal conveyor 17. Each hydraulic cylinder 23 is articulatedly fastened, by way of an end pointing toward the running gear 12, to the pivoting means 21, and by way of the opposite end, to an edge of the longitudinal conveyor 17. By virtue of the hydraulic cylinders 23 being retracted and extended in the same direction, the inclination of the longitudinal conveyor 17 relative to the pivoting means 21 can be varied in opposite directions, whereby the height of the offloading end 18 of the continuous conveyor 19 relative to the underlying surface 24 on which the feeding appliance can travel can be varied.

The longitudinal conveyor 17 is mounted on the coupling means 20 pivotably about a vertical pivot axis 25 by way of the pivoting means 21. Two opposite pressure medium cylinders, in particular hydraulic cylinders 26, are arranged on opposite sides between the coupling means 20 and the pivoting means 21. The hydraulic cylinders 26 are articulatedly fastened at one side to the coupling means 20 and at the other side to the pivoting means 21. By virtue of the two hydraulic cylinders 26 being retracted and extended in opposite directions, the longitudinal conveyor 17 is pivoted together with the pivoting means 21 about the vertical pivot axis 25, for example in order to position the offloading end 18 of the longitudinal conveyor 17 over the storage containers of different road-finishing machines travelling adjacent one another, and to thus enable material for producing the pavement surface to be supplied alternately to multiple road-finishing machines. The coupling means 20 and the pivoting means 21 are dimensioned such that, in all pivoting and tilting positions of the continuous conveyor 19, material for producing the pavement surface can be offloaded from the offloading end 15 of the continuous conveyor 14 onto the charging end 16 of the longitudinal conveyor 17.

In the exemplary embodiment shown, the offloading end 18 of the longitudinal conveyor 17 is assigned a tensioning drum which is displaceable in the longitudinal direction of the longitudinal conveyor 17. The tensioning drum can preferably be displaced in the longitudinal direction of the longitudinal conveyor 17 by means of pressure medium cylinders, in the exemplary embodiment shown hydraulic cylinders 27. The tensioning drum is simultaneously in the form of a drive drum. For this purpose, a drive is assigned to one end side of the tensioning drum. In the exemplary embodiment shown, said drive is a hydraulic motor 28 which is variable in terms of rotational speed. It is however also possible for other drives, for example electric motors, to be provided.

The longitudinal conveyor 17 can be coupled, by way of its coupling means 20, to the rear side of the running gear 12 of the feeding appliance. For this purpose, in the case of the feeding appliance shown, two spaced-apart hooking-in means 29 and two spaced-apart locking means 30 are provided. The locking means 30 are situated at different locations than the hooking-in means 29, preferably below the hooking-in means 29. The hooking-in means 29 and the locking means 30 are situated between a transverse side 31 on the rear side of the running gear 12 (as viewed in the paving direction 11) and a transverse side 32 on the front side, facing toward the running gear 12, of the coupling means 20. The two hooking-in means 29, which are identical, are of hook-like form, specifically such that, preferably merely by virtue of the longitudinal conveyor 17 with the coupling means 20 and the pivoting means 21 being lowered relative to the running gear 12, the longitudinal conveyor 17 is, by way of the coupling means 20, automatically hooked onto or hooked into the running gear 12 at the rear thereof. For this purpose, in the exemplary embodiment shown, two upwardly open depressions 33 are fixedly arranged on the rear transverse side 31 of the running gear 12, specifically one depression 33 per hooking-in means 29. Each upwardly open depression 33 on the running gear 12 forms a type of open hook. With each hook-like depression 33 corresponds a projection from the transverse side 32 of the coupling means 20. Each projection 34 is formed from a horizontal pin. The pin is fastened, at opposite ends, to lugs so as to be parallel to and spaced apart by a short distance from the transverse side 32 of the coupling means 20. The projections 34 correspond to the depressions 33 such that, during the lowering of the longitudinal conveyor 17 with the projections 34 fastened to its coupling means 20, said projections engage with the hook-like or claw-like depressions 33 from above. By means of depressions 33 that widen toward the upwardly open end, automatic orientation and centering of the projections 34 relative to the depressions 33 takes place as the projections 34 are inserted into the depressions 33 during the lowering of the longitudinal conveyor 17 with the coupling means 20.

The locking means 30 arranged below the hooking-in means 29 are designed so as to generate a connection, which exhibits positive locking in all directions, between the rear transverse side 31 of the running gear 12 and the front transverse side 32 of the coupling means 20. In the simplest case, each locking means 30 may be formed by at least one bolted connection. It is however also conceivable for each locking means 30 to be formed by at least one lug on the rear transverse side 31 of the running gear 12 and at least one lug, corresponding thereto, on the front transverse side 32 of the coupling means 20, wherein the lugs have aligned through bores through which a transversely oriented securing bolt is passed. This may be performed manually or in an automated fashion, for example by means of hydraulic cylinders whose piston rods form the respective bolts.

The method for conversion of the feeding appliance, specifically the attachment of the longitudinal conveyor 17 with the coupling means 20 and the pivoting means 21 to the running gear 12, will be described in more detail below:

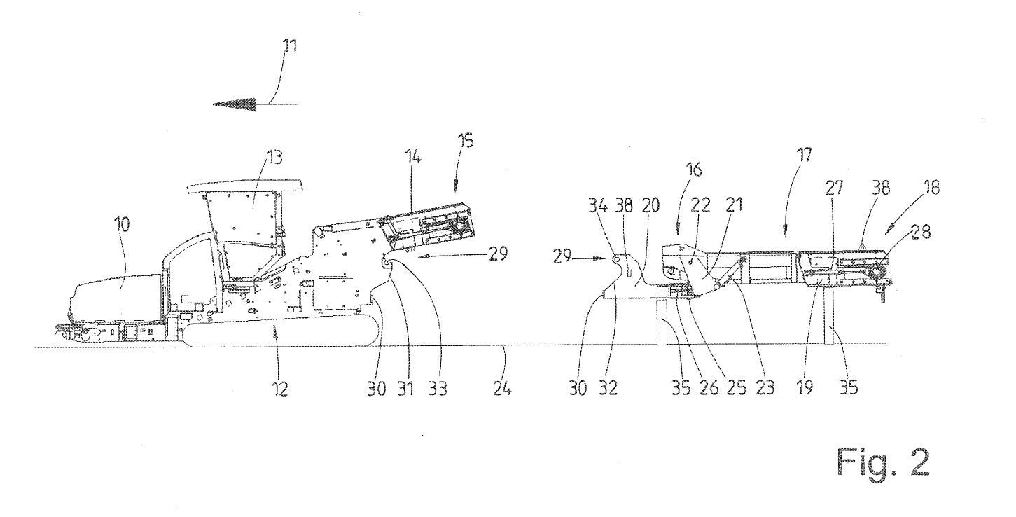

In the initial position shown in FIG. 2, the longitudinal conveyor 17 with the coupling means 20 and the pivoting means 21 is resting, in an approximately horizontal orientation, on at least two supports 35. If appropriate, the longitudinal conveyor 17 with the coupling means 20 and the pivoting means 21 may however also rest directly on the underlying surface 24 or on a transportation appliance, for example a low loader.

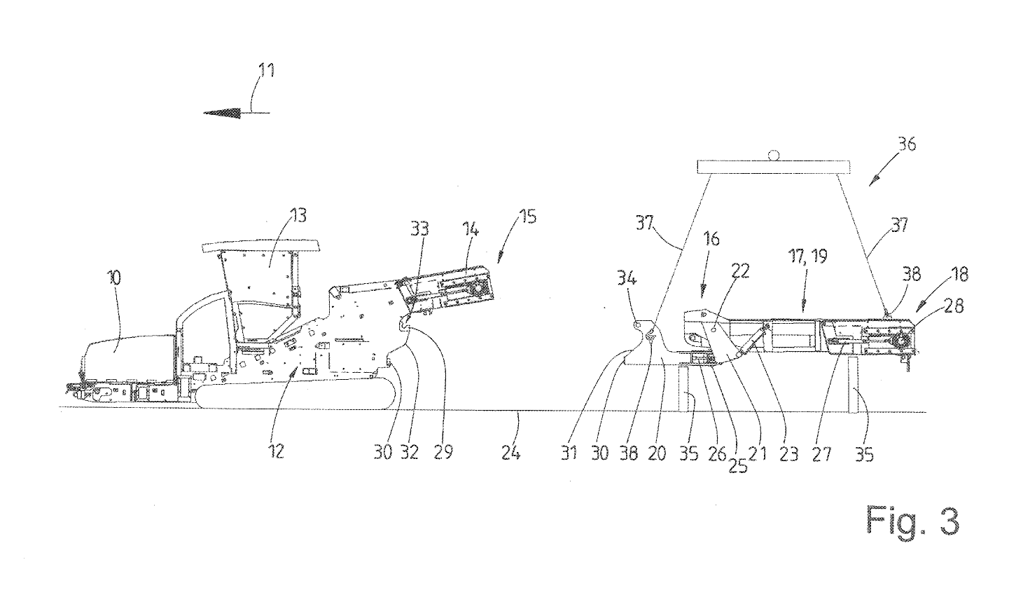

Now, in order to be attached to the feeding appliance, the set-down longitudinal conveyor 17 with the coupling means 20 and the pivoting means 21 is fastened to a lifting means, for example a crane. Of the lifting means, FIGS. 3 to 5 illustrate only the slinging means 36, which has four cables 37. The ends of the cables 37 are releasably hooked into two anchoring eyelets 38 in the region of the offloading end 18 of the longitudinal conveyor 17 and two anchoring eyelets 38 on the coupling means 20.

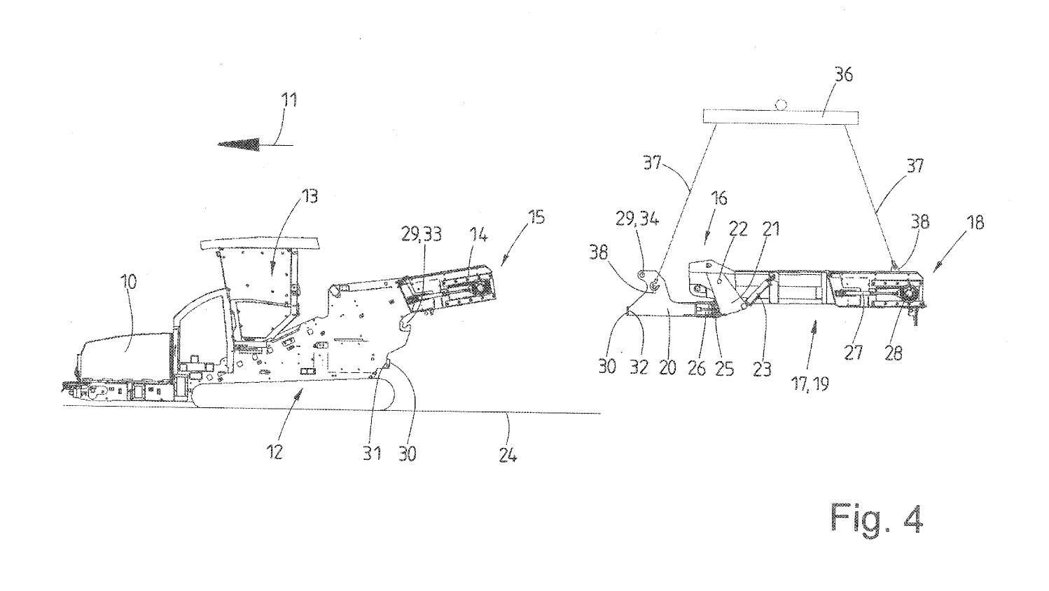

The longitudinal conveyor 17 with the coupling means 20 and the pivoting means 21 is now raised by the crane or similar so as to be freed from the supports 35. The longitudinal conveyor 17 with the coupling means 20 and the pivoting means 21 is raised to such an extent that, by subsequent lowering, it can be hooked by way of the projections 34 into the depressions 33 behind the running gear 12 of the feeding appliance. Said raised state of the longitudinal conveyor 17 with the coupling means 20 and the pivoting means 21 is shown in FIG. 4.

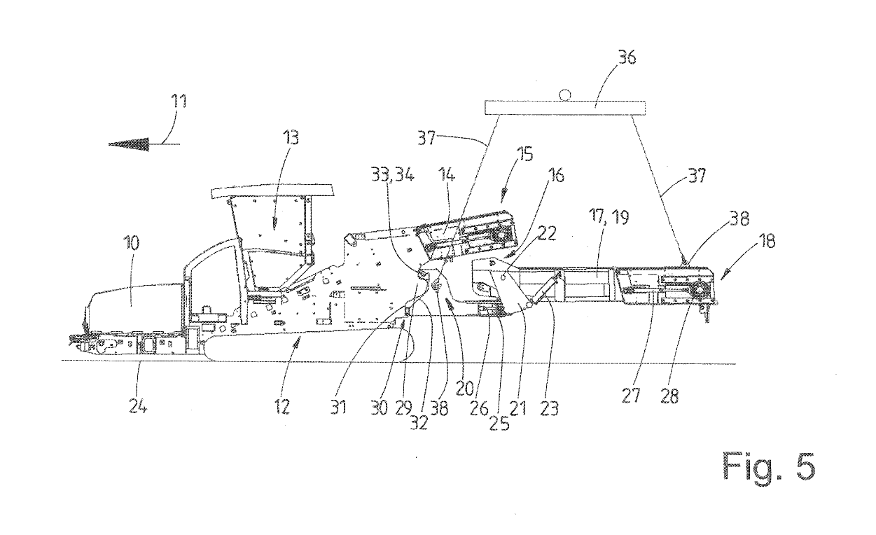

The longitudinal conveyor 17 with the coupling means 20 and the pivoting means 21, which is oriented preferably horizontally on the crane or the like, is then moved by means of the latter toward the rear side of the running gear 12 of the feeding appliance, for example in a pivoting movement, specifically to such an extent that the projections 34 on the coupling means 20 are situated above the depressions 33 of the hooks on the rear side of the running gear 12. By virtue of the longitudinal conveyor 17 with the coupling means 20 and the pivoting means 21 subsequently being lowered, the projections 34 pass automatically, and without additional measures, into the depressions 33 of the hooks on the rear side of the running gear 12. As a result, the longitudinal conveyor 17 with the coupling means 20 and the pivoting means 21 is pre-mounted on the running gear 12 of the feeding appliance, as shown in FIG. 5. After the crane or similar is lowered further, the pre-mounted longitudinal conveyor 17 with the coupling means 20 and the pivoting means 21 is already suspended on the running gear 12 of the feeding appliance. All that remains is for the locking means 30 below the hooking-in means 29 to be engaged by means of screws, bolts, hydraulic means or the like. The securing action may be produced when the cables 37 are still connected to the anchoring eyelets 38 on the coupling means 20 and on the longitudinal conveyor 17. If appropriate, the cables 37 may already have been relieved of load at the time at which the locking means 30 are engaged. It is also conceivable for the locking means 30 to first be engaged when the cables 37 of the slinging means 36 have already been released from the anchoring eyelets 38 on the coupling means 20 and on the longitudinal conveyor 17.

After the hooking-on and securing of the longitudinal conveyor 17 with the coupling means 20 and the pivoting means 21 onto the running gear 12 of the feeding appliance, all that remains is to produce hydraulic connections and/or electrical connections between the feeding appliance and the longitudinal conveyor 17, the coupling means 20 and the pivoting means 21. The electrical lines to the longitudinal conveyor 17 originate from at least one interface on the feeding appliance.

The detachment of the longitudinal conveyor 17 with the coupling means 20 and the pivoting means 21 is performed in the reverse sequence in relation to the attachment process described above.

The invention is also suitable if the above-described feeding appliance is implemented in such a way that either the longitudinal conveyor 17 has only a coupling means 20 but no pivoting means 21 or the longitudinal conveyor 17 is designed so as to be fastenable to the rear of the running gear 12 of the feeding appliance directly, without the coupling means 20 and/or without the pivoting means 21, by way of hooking-in means 29 and locking means 30.

### LIST OF REFERENCE NUMERALS

10 Storage container
11 Paving direction
12 Running gear
13 Operators' platform
14 Continuous conveyor
15 Offloading end
16 Charging end
17 Longitudinal conveyor
18 Offloading end
19 Continuous conveyor
20 Coupling means
21 Pivoting means
22 Tilt axis
23 Hydraulic cylinder
24 Underlying surface
25 Pivot axis
26 Hydraulic cylinder
27 Hydraulic cylinder
28 Hydraulic motor
29 Hooking-in means
30 Locking means
31 Transverse side
32 Transverse side
33 Depression
34 Projection
35 Support
36 Slinging means
37 Cable
38 Anchoring eyelet

What is claimed is:

1. A feeding appliance having a running gear (12) which is assigned, at the front as viewed in a paving direction (11), a storage container (10) for accommodating a supply of material, having a rear longitudinal conveyor (17) which is fastenable to the running gear (12), and having at least one conveyor that transports the material from the storage container (10) to the longitudinal conveyor (17), wherein the longitudinal conveyor (17) is connectable to the running gear (12) by way of at least one hooking-in means (29) and at least one locking means (30).

2. The feeding appliance according to claim 1, wherein at least one hooking-in means (29) is arranged at one location and the at least one locking means (30) is arranged at a different location, and preferably the at least one hooking-in means (29) is arranged above the at least one locking means (30).

3. The feeding appliance according to claim 1, wherein the longitudinal conveyor (17) is assigned a coupling means (20), and the longitudinal conveyor (17) with the coupling means (20) is connectable to the running gear (12) by way of the at least one hooking-in means (29) and the at least one locking means (30).

4. The feeding appliance according to claim 3, wherein the longitudinal conveyor (17), preferably with the coupling means (20), is immovably and/or rigidly connectable to the running gear (12).

5. The feeding appliance according to claim 3, wherein the or each hooking-in means (29) corresponds to an upwardly open depression (33) on the running gear (12) and a projection (34) on the coupling means (20), or a downwardly open depression on the coupling means (20) corresponds to a projection on the running gear (12).

6. The feeding appliance according to claim 5, wherein the locking means (30) is in the form of a positively locking connection, which acts preferably in all directions, between the coupling means (20) and the running gear (12), and the respective positive locking means (30) is assigned to the running gear (12) and to the coupling means (20), wherein the respective locking means (30) can be engaged after the hooking-in of the or each projection (34) into the corresponding depression (33).

7. The feeding appliance according to claim 3, wherein the longitudinal conveyor (17) is supported on the coupling means (20), preferably on an end region of the coupling means (20) directed away from the running gear (12), about a vertical or slightly inclined pivot axis (25).

8. The feeding appliance according to claim 7, wherein the longitudinal conveyor (17) is assigned a pivoting means (21) which is connected to the coupling means (20) pivotably about the pivot axis (25), and the longitudinal conveyor (17) is connected to the pivoting means (21) pivotably about a horizontal tilt axis (22).

9. The feeding appliance according to claim 8, wherein, between the coupling means (20) and the pivoting means (21), there is provided at least one linear drive for lateral pivoting of the longitudinal conveyor (17) with the pivoting means 21) about the pivot axis (25), and, between the pivoting means (21) and the longitudinal conveyor (17), there is provided at least one linear drive for pivoting the longitudinal conveyor (17) up and down about the tilt axis (22).

10. The feeding appliance according to claim 1, wherein the longitudinal conveyor (17) is assigned a drive, preferably a hydraulic drive, for its encircling conveyor, and in particular the drive is assigned to an offloading end (18), which is directed away from the running gear (12), of the longitudinal conveyor (17).
